(19) United States
(12) Patent Application Publication
(10) Pub. No.: US 2017/0211857 A1
(43) Pub. Date: Jul. 27, 2017

(54) EVAPORATOR

(71) Applicant: DENSO CORPORATION, Kariya-city, Aichi-pref. (JP)

(72) Inventors: Kota TAKEICHI, Kariya-city (JP); Yoshiaki TAKANO, Kariya-city (JP); Haruyuki NISHIJIMA, Kariya-city (JP); Yoshiyuki YOKOYAMA, Kariya-city (JP)

(21) Appl. No.: 15/500,646

(22) PCT Filed: Jul. 27, 2015
(86) PCT No.: PCT/JP2015/003740

§ 371 Date: Jan. 31, 2017

(30) Foreign Application Priority Data
Aug. 4, 2014 (JP) 2014-158487
Jul. 10, 2015 (JP) 2015-138547

(51) Int. Cl. F25B 39/00; B60H 1/32; F25B 31/00

(52) U.S. Cl. CPC F25B 39/00; F25B 31/002; B60H 1/3227; F25B 2341/0011; F25B 39/02

(57) ABSTRACT

An evaporator includes an inlet side space of a leeward side upper tank into which a refrigerant flows from a refrigerant inlet port, and an inlet side turn path that is formed of a group of tubes and connected to the inlet side space. A ratio of a total passage cross-sectional area AT1 of the group of tubes forming the inlet side turn path to an inlet passage cross-sectional area Ain of the refrigerant inlet port is set at 3.5 or less, and a ratio of a longitudinal direction length Lg1 of the inlet side space to an inlet equivalent diameter Din of the refrigerant inlet port is set at 25 or less. Further, a Reynolds number Re of the refrigerant that has flowed into the inlet side turn path is set at 1800 or more.

### CROSS REFERENCE TO RELATED APPLICATIONS

This application is based on and incorporates herein by reference Japanese Patent Applications No. 2014-158487 filed on Aug. 4, 2014, and No. 2015-138547 filed on Jul. 10, 2015.

### TECHNICAL FIELD

The present disclosure relates to an evaporator that evaporates a refrigerant in a refrigeration cycle device.

### BACKGROUND ART

Up to now, a refrigeration cycle device having an ejector as a refrigerant depressurizing device (hereinafter referred to as “ejector refrigeration cycle”) has been known.

For example, Patent Document 1 discloses the ejector refrigeration cycle having a cycle configuration in which a refrigerant depressurized by a nozzle portion of an ejector is allowed to flow into a gas-liquid separator, a gas-phase refrigerant separated by the gas-liquid separator is drawn into a compressor, and a liquid-phase refrigerant separated by the gas-liquid separator is allowed to flow into an evaporator through a depressurizing device such as a fixed throttle.

In addition, Patent Document 2 discloses an ejector with a gas-liquid separation function in which the ejector and the gas-liquid separator are integrated together, thereby being capable of easily configuring the ejector refrigeration cycle of the same cycle configuration as that in Patent Document 1.

Incidentally, in a vapor compression refrigeration cycle device, in general, a refrigerator oil for lubricating the compressor is mixed in the refrigerant. As the refrigerator oil of this type, a refrigerator oil having a compatibility with a liquid-phase refrigerant is employed.

For that reason, in the ejector refrigeration cycle of Patent Document 1, a large amount of refrigerator oil is dissolved in the liquid-phase refrigerant separated by the gas-liquid separator, and a refrigerator oil concentration in the liquid-phase refrigerant flowing into the evaporator is likely to become high. Further, when the refrigerator oil concentration in the liquid-phase refrigerant flowing into the evaporator becomes high, the amount of refrigerator oil staying in the evaporator is increased, resulting in a risk that a heat exchanging performance of the evaporator is deteriorated. In addition, since in the ejector refrigeration cycle of Patent Document 1, since the liquid-phase refrigerant separated by the gas-liquid separator is introduced into a refrigerant inlet port side, a vapor quality of the refrigerant flowing into the evaporator is relatively low. When the vapor quality of the refrigerant flowing into the evaporator is relatively low, a flow velocity of the refrigerant that has flowed into the evaporator is decreased with the result that distributivity in distribution of the refrigerant that has flowed into the evaporator to each tube may be deteriorated. “The distributivity is deteriorated” means that it is difficult to evenly distribute the refrigerant that has flowed into the evaporator to each tube. For that reason, a temperature inhomogeneous distribution may occur in a blown air that is a fluid to be cooled.

### PRIOR ART DOCUMENT

### Patent Document

Patent Document 1: JP 4032875 B2

Patent Document 2: JP 2013-177879 A

### SUMMARY

In view of the above-described points, it is one object of the present disclosure to homogenize an inhomogeneous temperature distribution occurring in a fluid cooled by an evaporator having a refrigerant inlet port into which a liquid-phase refrigerant separated by a gas-liquid separator is introduced.

Also, it is another object of the present disclosure to homogenize an inhomogeneous temperature distribution occurring in a fluid cooled in an evaporator into which a refrigerant having a relatively low vapor quality flows.

According to an aspect of the present disclosure, an evaporator is used for a vapor compression refrigeration cycle device in which a refrigerator oil is mixed with a refrigerant. The evaporator includes a refrigerant inlet port into which a liquid-phase refrigerant obtained via separation of the refrigerant by a gas-liquid separator is introduced, a heat exchanging unit that includes a plurality of tubes which are stacked and allow the refrigerant to flow therein and performs a heat exchange between the refrigerant and a fluid to be cooled, and a tank that extends in a stacking direction of the plurality of tubes, is connected to ends of the plurality of tubes, and gathers the refrigerant from the plurality of tubes or distributes the refrigerant to the plurality of tubes. Fluid paths, each of which is provided by a group of the plurality of tubes that allows the refrigerant distributed from one space in the tank to flow in the same direction, are defined as turn paths. The tank has an inlet side space into which the refrigerant flows from the refrigerant inlet port. One of the turn paths connected to the inlet side space is defined as an inlet side turn path. It is defined that p is a density of the refrigerant flowing into the inlet side space, Gr is a mass flow rate of the refrigerant flowing into the inlet side space, AT1 is a total passage cross-sectional area of a group of the plurality of tubes forming the inlet side turn path, φDa is a total equivalent diameter of the total passage cross-sectional area, and μ is a saturated liquid viscosity coefficient of the refrigerant flowing into the inlet side space. A Reynolds number Re of the refrigerant that has flowed into the inlet side turn path is represented by Re=ρ×u×φDa/μ, where u=Gr/ρ×AT1, and Re≧1800 is satisfied.

According to the above configuration, since the Reynolds number of the refrigerant that has flowed into the tubes forming the inlet side turn path is set at 1800 or more, the flow velocity of the refrigerant to flow from the refrigerant inlet port into the inlet side space is not largely decreased.

Therefore, even in the evaporator where the liquid-phase refrigerant separated by the gas-liquid separator is introduced into the refrigerant inlet port side, the distributivity in distribution of the refrigerant to each tube forming the inlet side turn path from the inlet side space can be restrained from deteriorating.

In this example, the refrigerant flowing in the inlet side turn path becomes relatively low in vapor quality in the evaporator. For that reason, when the refrigerant mixed with the refrigerator oil flows in a heat exchanging region on an inlet side of the heat exchanging unit formed of the inlet side turn path, the refrigerant is capable of exerting a high cooling performance.

Therefore, the distributivity in distribution of the refrigerant to each tube forming the inlet side turn path is restrained from deteriorating, and the inhomogeneous temperature distribution occurring in the cooled fluid in the heat exchanging region on the inlet side of the heat exchanging unit can be homogenized effectively.

As a result, even in the evaporator in which the liquid-phase refrigerant separated by the gas-liquid separator is introduced into the refrigerant inlet port, the inhomogeneous temperature distribution occurring in the cooled fluid to be cooled can be homogenized.

Incidentally, “the evaporator in which the liquid-phase refrigerant separated by the gas-liquid separator is introduced into the refrigerant inlet port” is not limited only to an evaporator in which the liquid-phase refrigerant separated by the gas-liquid separator flows into the refrigerant inlet port while the liquid-phase refrigerant is kept in the liquid-phase state. The above evaporator includes an evaporator in which the liquid-phase refrigerant is changed into a gas-liquid two-phase refrigerant having a slight vapor quality through a depressurizing device or the like and flows into the refrigerant inlet port. Further, in that case, the vapor quality of the refrigerant flowing into the refrigerant inlet port may be 0.2 or less.

Also, “the refrigerant that has flowed into the tube” may be expressed by “the refrigerant immediately after flowing into the tube”. In addition, “the refrigerant flowing into the inlet side space” may be expressed by “the refrigerant immediately before flowing into the inlet side space from the refrigerant inlet port”, or “the refrigerant immediately after flowing into the inlet side space from the refrigerant inlet port”.

According to a second aspect of the present disclosure, an evaporator is used for a vapor compression refrigeration cycle device in which a refrigerator oil is mixed with a refrigerant. The evaporator includes a refrigerant inlet port into which a liquid-phase refrigerant obtained via separation of the refrigerant by a gas-liquid separator is introduced, a heat exchanging unit that includes a plurality of tubes which are stacked and allow the refrigerant to flow therein and performs a heat exchange between the refrigerant and a fluid to be cooled, and a tank that extends in a stacking direction of the plurality of tubes, is connected to ends of the plurality of tubes, and gathers the refrigerant from the plurality of tubes or distributes the refrigerant to the plurality of tubes. Fluid paths, each of which is provided by a group of the plurality of tubes that allows the refrigerant distributed from one space in the tank to flow in the same direction, are defined as turn paths. The tank has an inlet side space into which the refrigerant flows from the refrigerant inlet port. One of the turn paths connected to the inlet side space is defined as an inlet side turn path. It is defined that an inlet passage cross-sectional area of the refrigerant inlet port is Ain, and a total passage cross-sectional area of a group of the plurality of tubes forming the inlet side turn path is AT1. AT1/Ain≦3.5 is satisfied. It is defined that an input equivalent diameter of the refrigerant inlet port is Din, and a length of the inlet side space in the stacking direction is Lg1. Lg1/Din≦25 is satisfied.

According to the above configuration, the ratio AT1/Ain of the total passage cross-sectional area AT1 to the inlet passage cross-sectional area Ain is 3.5 or less. Therefore, the flow velocity of the refrigerant flowing into the tubes forming the inlet side turn path is not largely decreased.

Further, a ratio Lg1/Din of a longitudinal direction length Lg1 to an inlet equivalent diameter Din is 25 or less. Therefore, the refrigerant that has flowed into the inlet side space can arrive at a tube most distant from the refrigerant inlet port.

As a result, the distributivity in distribution of the refrigerant from the inlet side space to each tube forming the inlet side turn path can be restrained from deteriorating. As in the first aspect of the present disclosure, the inhomogeneous temperature distribution occurring in the cooled fluid in the heat exchanging unit can be homogenized in the overall evaporator.

According to a third aspect of the present disclosure, an evaporator is used for a vapor compression refrigeration cycle device in which a refrigerator oil is mixed with a refrigerant. The evaporator includes a refrigerant inlet port into which a liquid-phase refrigerant obtained via separation of the refrigerant by a gas-liquid separator is introduced, a heat exchanging unit that includes a plurality of tubes which are stacked and allow the refrigerant to flow therein and performs a heat exchange between the refrigerant and a fluid to be cooled, and a tank that extends in a stacking direction of the plurality of tubes, is connected to ends of the plurality of tubes, and gathers the refrigerant from the plurality of tubes or distributes the refrigerant to the plurality of tubes. The plurality of tubes are stacked into a first row and a second row. The heat exchanging unit includes a windward side heat exchanging unit that includes the first row of the plurality of tubes and performs a heat exchange between the refrigerant and the fluid to be cooled, and a leeward side heat exchanging unit that is disposed on a downstream side of the windward side heat exchanging unit in a flow direction of the fluid to be cooled, the leeward side heat exchanging unit including the second row of the plurality of tubes and performing a heat exchange between the refrigerant and the fluid to be cooled. A refrigerant flow channel in the windward side heat exchanging unit and a refrigerant flow channel in the leeward side heat exchanging unit are connected to each other such that the refrigerant that has flowed into the refrigerant inlet port passes through one of the windward side heat exchanging unit and the leeward side heat exchanging unit and thereafter passes through another of the windward side heat exchanging unit and the leeward side heat exchanging unit. The refrigeration cycle device is configured to obtain 0.2 or less in vapor quality of the refrigerant that flows into the refrigerant inlet port. One of the windward side heat exchanging unit and the leeward side heat exchanging unit is configured to obtain 0.4 or more in vapor quality of the refrigerant flowing out of the one of the windward side heat exchanging unit and the leeward side heat exchanging unit and flowing into another of the windward side heat exchanging unit and the leeward side heat exchanging unit.

According to the above configuration, the refrigerant having the relatively low vapor quality (specifically, the refrigerant of the vapor quality of about 0.2 to 0.4) can be evaporated in one of the windward side heat exchanging unit and the leeward side heat exchanging unit. In addition, in the other heat exchanging unit, the refrigerant having the relatively high vapor quality (specifically, the refrigerant of the vapor quality of 0.4 or more) can be evaporated.

Therefore, when the refrigerant mixed with the refrigerator oil flows into the evaporator, one of the heat exchanging units can be used as a region in which the high cooling capacity is exerted. According to the above configuration, the inhomogeneous temperature distribution occurring in the cooled fluid by the windward side heat exchanging unit and the inhomogeneous temperature distribution occurring in the cooled fluid by the leeward side heat exchanging unit can be homogenized.

As a result, even in the evaporator that allows the refrigerant having the relatively low vapor quality to flow, the inhomogeneous temperature distribution occurring in the cooled fluid by the heat exchanging unit can be homogenized in the overall evaporator.

### BRIEF DESCRIPTION OF THE DRAWINGS

FIG. 1 is a schematic diagram of an ejector refrigeration cycle according to a first embodiment of the present disclosure.

FIG. 2 is a perspective view illustrating an evaporator according to the first embodiment.

FIG. 3 is a schematic diagram illustrating a refrigerant flow in an evaporator according to the first embodiment.

FIG. 4 is a schematic cross-sectional diagram illustrating a portion IV in FIG. 3.

FIG. 5 is a Mollier diagram illustrating a state of a refrigerant in the ejector refrigeration cycle according to the first embodiment.

FIG. 6 is a graph illustrating a relationship between a refrigerator oil concentration in a liquid-phase refrigerant flowing into the evaporator and a cooling performance of the overall evaporator.

FIG. 7 is a graph illustrating a relationship between a vapor quality of the refrigerant in a refrigerant flow channel in the evaporator and a local heat transfer coefficient.

FIG. 8 is a graph illustrating a relationship between the refrigerator oil concentration in the liquid-phase refrigerant flowing into the evaporator and a cooling performance of the overall evaporator when changing a Reynolds number.

FIG. 9 is a graph illustrating a relationship between the refrigerator oil concentration and the cooling performance when changing dimensional data of the evaporator.

FIG. 10 is a schematic view illustrating a refrigerant flow in an evaporator according to a second embodiment of the present disclosure.

FIG. 11 is a schematic diagram of an ejector refrigeration cycle according to a third embodiment of the present disclosure.

### DESCRIPTION OF EMBODIMENTS

The present inventors have tested and studied an ejector refrigeration cycle of a cycle configuration in which a refrigerant depressurized by a nozzle portion of an ejector is allowed to flow into a gas-liquid separator, a gas-phase refrigerant separated by the gas-liquid separator is drawn into a compressor, and a liquid-phase refrigerant separated by the gas-liquid separator is allowed to flow into an evaporator through a depressurizing device such as a fixed throttle. According to the present inventors' test and study, it has been confirmed that in the ejector refrigeration cycle, a refrigerator oil concentration in the liquid-phase refrigerant to flow into the evaporator is increased to a predetermined concentration (specifically, about 5 wt %) to improve the cooling capacity of the overall evaporator. In more detail, it has been confirmed that the refrigerator oil concentration is brought closer to a predetermined concentration (hereinafter referred to as “peak concentration”) to maximize the cooling capacity as the overall evaporator.

Incidentally, the cooling capacity of the evaporator represents a capacity for cooling a predetermined flow rate of the fluid to be cooled to a predetermined temperature by the evaporator.

Under the circumstances, the present inventors have investigated a mechanism in which the refrigerator oil concentration in the liquid-phase refrigerant to flow into the evaporator is brought into closer to the peak concentration, to thereby improve the cooling capacity of the evaporator in the ejector refrigeration cycle in detail.

With the above investigation, it has been found that in the ejector refrigeration cycle, the vapor quality of the refrigerant to flow into the evaporator becomes a relatively low value (specifically, the vapor quality of 0.2 or less), to thereby improve the cooling capacity of the evaporator.

In more detail, in the ejector refrigeration cycle, since the liquid-phase refrigerant separated by the gas-liquid separator is introduced to the refrigerant inlet port side of the evaporator, the vapor quality of the refrigerant to flow into the evaporator becomes relatively low. Furthermore, in the refrigerant having the relatively low vapor quality, the refrigerator oil concentration is brought closer to the peak concentration, and grains of the refrigerator oil serve as boiling nucleus to promote the boiling of the liquid-phase refrigerant.

The heat transfer coefficient in the tubes configuring the heat exchanging unit in which the grains of the refrigerator oil promote the boiling of the liquid-phase refrigerant to perform the heat exchange between the refrigerant and the fluid to be cooled can be improved, and the cooling capacity of the evaporator can be improved.

On the other hand, the heat transfer coefficient described above is improved in the tubes in which the refrigerant having the relatively low vapor quality flows, that is, the tubes disposed at a refrigerant flow upstream side among the tubes configuring the evaporator. In the tubes disposed at the refrigerant flow downstream side, since the evaporation of the refrigerant is progressed to increase the vapor quality, not only the improvement in the heat transfer coefficient cannot be expected but also the heat exchanging performance may be deteriorated by an increase in the refrigerator oil concentration.

In addition, when the vapor quality of the refrigerant to flow into the evaporator is relatively low, since the flow velocity of the refrigerant that has flowed into the evaporator is decreased, the distributivity of distributing the refrigerant that has flowed into the evaporator to each tube may be deteriorated. Incidentally, “the distributivity is deteriorated” means that it is difficult to evenly distribute the refrigerant that has flowed into the evaporator to each tube.

For that reason, it has been found that when the ejector refrigeration cycle is applied to an air conditioning apparatus, the refrigerator oil concentration to flow into the evaporator is set to the peak concentration, and a blown air to be blown into a space to be air-conditioned by the evaporator is cooled, the cooling capacity of the evaporator can be improved, and the inhomogeneous temperature distribution is likely to occur in the blown air that is the fluid to be cooled.

For example, an evaporator into which the refrigerant having the relative low vapor quality and having a predetermined refrigerator oil concentration (specifically, the refrigerant having the vapor quality of 0.2 or less and the refrigerator oil concentration of 5 wt %) flows is defined as a first evaporator. Further, an evaporator that does not obtain the effect of improving the heat transfer coefficient caused by the above-mentioned refrigerator oil (specifically, the evaporator into which the refrigerant having the vapor quality of 0.4 or more flows) is defined as a second evaporator. In this situation, it has been confirmed that as compared with the second evaporator, the first evaporator deteriorates the temperature distribution of the blown air.

Hereinafter, multiple embodiments for implementing the present invention will be described referring to drawings. In the respective embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

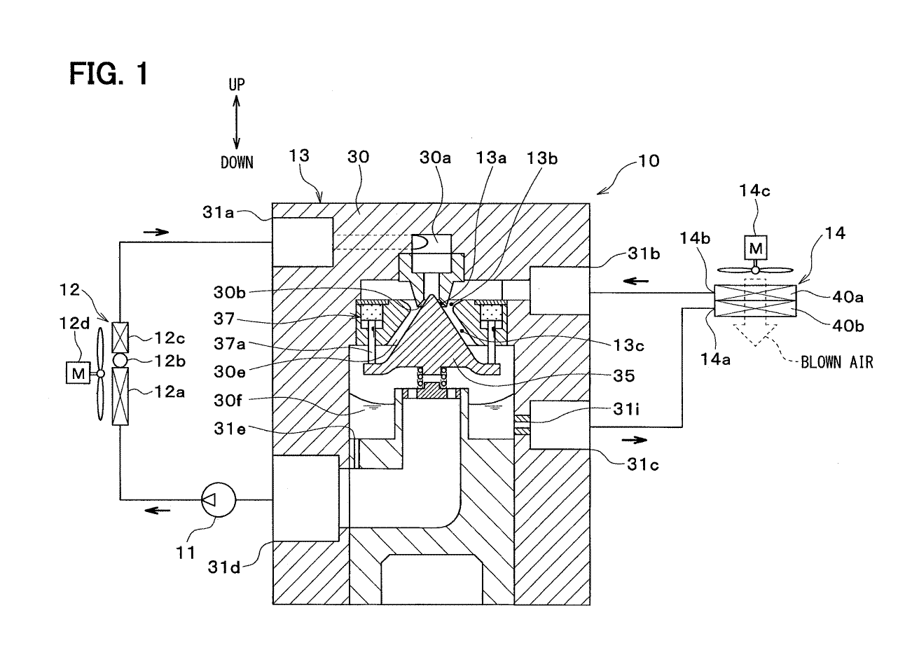

A first embodiment of the present disclosure will be described with reference to FIGS. 1 to 9. As illustrated in an overall configuration diagram of FIG. 1, an evaporator 14 according to the present embodiment is applied to a vapor compression refrigeration cycle device having an ejector 13 as a refrigerant depressurizing device, that is, an ejector refrigeration cycle 10. Moreover, the ejector refrigeration cycle 10 is applied to a vehicle air conditioning apparatus, and performs a function of cooling a blown air to be blown into a vehicle interior that is a space to be air-conditioned.

The ejector refrigeration cycle 10 employs an HFC based refrigerant (specifically, R134a) as the refrigerant, and configures a subcritical refrigeration cycle in which a high pressure-side refrigerant pressure does not exceed a critical pressure of the refrigerant. The ejector refrigeration cycle 10 may employ an HFO based refrigerant (specifically, R1234yf) or the like as the refrigerant.

A refrigerator oil for lubricating a compressor 11 is mixed with the refrigerant, and a part of the refrigerator oil circulates in the cycle together with the refrigerant. As the refrigerator oil of this type, a refrigerator oil having a compatibility with a liquid-phase refrigerant is employed. Further, the amount of refrigerator oil allowing a refrigerator oil concentration in the refrigerant to flow into a refrigerant inlet port 14a of the evaporator 14 to be described later to be set to about 5 wt % is mixed during normal operation of the ejector refrigeration cycle 10.

First, in the ejector refrigeration cycle 10, the compressor 11 draws the refrigerant, pressurizes the refrigerant to a high-pressure refrigerant, and discharges the refrigerant. More specifically, the compressor 11 according to the present embodiment is an electric compressor that is configured by accommodating a fixed-capacity-type compression mechanism and an electric motor for driving the compression mechanism in one housing.

Any of various types of compression mechanisms, such as a scroll-type compression mechanism and a vane-type compression mechanism, can be employed as the compression mechanism. In addition, operation (number of rotations) of the electric motor is controlled according to a control signal output from a control device, which will be described below, and any type of an AC motor and a DC motor can be employed.

A refrigerant inlet side of a condensing portion 12a of a radiator 12 is connected to a discharge port of the compressor 11. The radiator 12 is a radiation heat exchanger that performs a heat exchange between the high-pressure refrigerant discharged from the compressor 11 and a vehicle exterior air (outside air) blown by a cooling fan 12d to radiate the heat from the high-pressure refrigerant and cool the high-pressure refrigerant.

More specifically, the radiator 12 is a so-called subcooling condenser including a condensing portion 12a, a receiver portion 12b, and a subcooling portion 12c. The condensing portion 12a performs the heat exchange between a high pressure gas-phase refrigerant discharged from the compressor 11 and an outside air blown from the cooling fan 12d, and radiates the heat from the high pressure gas-phase refrigerant to condense the high pressure gas-phase refrigerant. The receiver portion 12b separates gas and liquid of the refrigerant that has flowed out of the condensing portion 12a and stores an excess liquid-phase refrigerant. The subcooling portion 12c performs the heat exchange between the liquid-phase refrigerant that has flowed out of the receiver portion 12b and the outside air blown from the cooling fan 12d and subcools the liquid-phase refrigerant.

The cooling fan 12d is an electric blower, the rotating speed (the amount of blown air) of which is controlled by a control voltage output from the control device. A refrigerant inlet port 31a of the ejector 13 is connected to a refrigerant outlet side of the subcooling portion 12c of the radiator 12.

The ejector 13 functions as a refrigerant depressurizing device for depressurizing the high pressure liquid-phase refrigerant of the subcooling state, which has flowed out of the radiator 12, and allowing the refrigerant to flow to the downstream side. The ejector 13 also functions as a refrigerant circulating device (refrigerant transport device) for drawing (transporting) the refrigerant that has flowed out of an evaporator 14 to be described later by the drawing action of a refrigerant flow ejected at high speed to circulate the refrigerant.

Further, the ejector 13 according to the present embodiment functions as a gas-liquid separator for separating the depressurized refrigerant into gas and liquid. In other words, the ejector 13 according to the present embodiment is configured as an ejector (ejector module) with a gas-liquid separation function. The respective up and down arrows in FIG. 1 indicate up and down directions in a state where the ejector 13 is mounted in the vehicle.

In more detail, as illustrated in FIG. 1, the ejector 13 according to the present embodiment includes a body 30 configured by the combination of multiple components. The body 30 is made of prismatic or cylindrical metal or plastic. The body 30 is provided with multiple refrigerant inlet ports and multiple internal spaces.

The multiple refrigerant inlet ports provided in the body 30 include a refrigerant inlet port 31a, a refrigerant suction port 31b, a liquid-phase refrigerant outlet 31c, a gas-phase refrigerant outlet port 31d, and so on. The refrigerant inlet port 31a allows the refrigerant that has flowed out of the radiator 12 to flow into the body 30. The refrigerant suction port 31b draws the refrigerant that has flowed out of the evaporator 14. The liquid-phase refrigerant outlet port 31c allows the liquid-phase refrigerant separated by a gas-liquid separation space 30f provided in the body 30 to flow to the refrigerant inlet side of the evaporator 14. The gas-phase refrigerant outlet port 31d allows the gas-phase refrigerant separated by the gas-liquid separation space 30f to flow to the intake side of the compressor 11.

The internal space provided in the body 30 includes a swirling space 30a, a depressurizing space 30b, a pressurizing space 30e, the gas-liquid separation space 30f, and so on. The swirling space 30a swirls the refrigerant that has flowed from the refrigerant inlet port 31a. The depressurizing space 30b reduces the pressure of the refrigerant that has flowed out of the swirling space 30a. The pressurizing space 30e allows the refrigerant that has flowed out of the depressurizing space 30b to flow into the pressurizing space 30e. The gas-liquid separation space 30f separates the refrigerant that has flowed out of the pressurizing space 30e into gas and liquid.

The swirling space 30a and the gas-liquid separation space 30f are each shaped into a substantially cylindrical rotating body. The depressurizing space 30b and the pressurizing space 30e are each shaped into a substantially truncated cone-shaped rotating body that gradually expands toward the gas-liquid separation space 30f side from the swirling space 30a side. All of the center axes of those spaces are disposed coaxially. Incidentally, the rotating body represents a three-dimensional shape provided when rotating a plane figure around one straight line (center axis) on the same plane.

Further, the body 30 is provided with a suction passage 13b, and the suction passage 13b introduces the refrigerant drawn from the refrigerant suction port 31b to a downstream side of the depressurizing space 30b in the refrigerant flow and an upstream side of the pressurizing space 30e in the refrigerant flow.

A passage formation member 35 is disposed in the depressurizing space 30b and the pressurizing space 30e. The passage formation member 35 is formed in an approximately cone shape which gradually expands more toward an outer peripheral side with distance from the depressurizing space 30b, and a center axis of the passage formation member 35 is also disposed coaxially with the center axis of the depressurizing space 30b and so on.

A refrigerant passage is provided between an inner peripheral surface of a portion providing the depressurizing space 30b and the pressurizing space 30e of the body 30 and a conical side surface of the passage formation member 35. A shape of an axial vertical cross-section of the refrigerant passage is annular (a donut shape in which a small-diameter circular shape coaxially disposed is removed from a circular shape).

In the above refrigerant passage, a refrigerant passage provided between a portion providing the depressurizing space 30b of the body 30 and a portion of the conical side surface of the passage formation member 35 on an apex side is shaped to narrow a passage cross-sectional area toward a refrigerant flow downstream side. With that shape, the refrigerant passage configures a nozzle passage 13a that functions as a nozzle which reduces the pressure of the refrigerant in an entropic manner and ejects the refrigerant.

In more detail, the nozzle passage 13a according to the present embodiment is shaped to gradually reduce a passage cross-sectional area toward a minimum passage area portion from an inlet side of the nozzle passage 13a, and gradually expand the passage cross-sectional area from the minimum passage area portion toward an outlet side of the nozzle passage 13a. In other words, in the nozzle passage 13a according to the present embodiment, the refrigerant passage cross-sectional area is changed as in a so-called “Laval nozzle”.

A refrigerant passage provided between a portion forming the pressurizing space 30e of the body 30 and a downstream portion of the conical side surface of the passage formation member 35 is shaped to gradually expand the passage cross-sectional area toward the refrigerant flow downstream side. With that configuration, the refrigerant passage configures a diffuser passage 13c functioning as a diffuser which mixes an ejection refrigerant ejected from the nozzle passage 13a with a suction refrigerant drawn from the refrigerant suction port 31b to increase the pressure.

An element 37 functioning as a drive device for displacing the passage formation member 35 to change the passage cross-sectional area of the minimum passage area portion of the nozzle passage 13a is disposed in the body 30. In more detail, the element 37 has a diaphragm that is displaced according to a temperature and a pressure of the refrigerant (that is, refrigerant flowing out of the evaporator 14) which flows in the suction passage 13b. The displacement of the diaphragm is transferred to the passage formation member 35 through an actuating bar 37a, to thereby displace the passage formation member 35 in a vertical direction.

Further, with an increase in the temperature (the degree of superheat) of the refrigerant flowing out of the evaporator 14, the element 37 displaces the passage formation member 35 so as to expand the passage cross-sectional area of the minimum passage area portion (toward the lower side of the vertical direction). On the other hand, with a decrease in the temperature (the degree of superheat) of the refrigerant flowing out of the evaporator 14, the element 37 displaces the passage formation member 35 so as to reduce the passage cross-sectional area of the minimum passage area portion (toward the upper side of the vertical direction).

In the present embodiment, the element 37 displaces the passage formation member 35 according to the degree of superheating of the refrigerant flowing out of the evaporator 14 as described above. As a result, the passage cross-sectional area of the minimum passage area portion of the nozzle passage 13a is adjusted so that the degree of superheating of the refrigerant present on the outlet side of the evaporator 14 comes closer to a predetermined value.

The gas-liquid separation space 30f is disposed on a lower side of the passage formation member 35. The gas-liquid separation space 30f configures a gas-liquid separator of a centrifugation type which swirls the refrigerant that has flowed out of the diffuser passage 13c around a center axis and separates gas and liquid of the refrigerant by the action of a centrifugal force. Therefore, the gas-liquid separation space 30f according to the present embodiment separates the gas and liquid of the refrigerant depressurized to a pressure lower than that of the discharged refrigerant discharged from the compressor 11 through the nozzle passage 13a.

Further, the gas-liquid separation space 30f has an internal capacity insufficient to substantially accumulate an excessive refrigerant even if a load is varied in the cycle, and the refrigerant circulation flow rate that is circulated in the cycle is varied.

In addition, an oil return hole 31e is provided in a portion defining a bottom surface of the gas-liquid separation space 30f in the body 30. The oil return hole 31e returns the refrigerator oil in the separated liquid-phase refrigerant to a gas-phase refrigerant passage side that connects the gas-liquid separation space 30f to the liquid-phase refrigerant outlet port 31c. In addition, an orifice 31i is disposed in the liquid-phase refrigerant passage that connects the gas-liquid separation space 30f to the liquid-phase refrigerant outlet port 31c. The orifice 31i functions as a depressurizing device for reducing the pressure of the refrigerant that is allowed to flow into the evaporator 14.

The liquid-phase refrigerant outlet port 31c of the ejector 13 is connected with the refrigerant inlet port 14a side of the evaporator 14. The evaporator 14 is a heat-absorbing heat exchanger that performs a heat exchange between the low-pressure refrigerant depressurized by the ejector 13 and the blown air that is blown into the vehicle interior from a blower fan 14c, to thereby evaporate the low-pressure refrigerant and exert a heat absorbing effect. Therefore, a fluid to be cooled according to the present embodiment is the blown air. The blower fan 14c is an electric blower, a rotation speed (the amount of blown air) of which is controlled by a control voltage output from the control device.

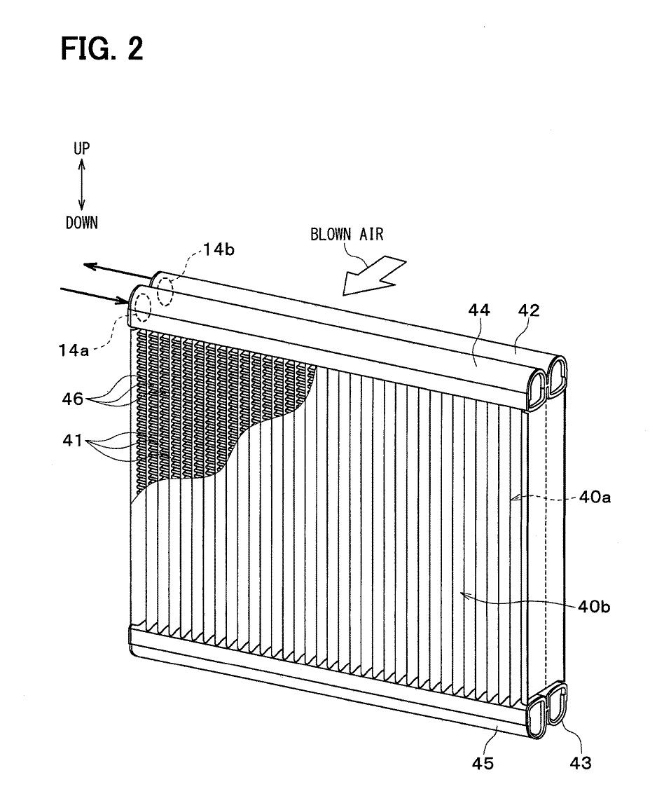

A detailed configuration of the evaporator 14 will be described with reference to FIGS. 2 to 4. Incidentally, respective up and down arrows in FIGS. 2 to 4 indicate up and down directions in a state where the evaporator 14 is mounted in the vehicle. The evaporator 14 according to the present embodiment is configured by a so-called tank-and-tube type heat exchanger including multiple tubes 41 in which the refrigerant flows, and tanks 42 to 45 that are connected to both ends of the multiple tubes 41 in a longitudinal direction and gather or distribute the refrigerant.

The tubes 41 are flat tubes that are made of metal (aluminum alloy in the present embodiment) excellent in a heat transfer property, and are shaped into a flat in a cross-section perpendicular to a flow direction (a longitudinal direction of the tubes 41) of the refrigerant that flows in the tubes 41. Further, the respective tubes 41 are stacked in two rows (that is, a first row and a second row) in the longitudinal direction (a substantially horizontal direction in the present embodiment) of the tanks 42 to 45.

In this situation, the respective tubes 41 are disposed so that planar surfaces (flat surfaces) of the respective outer surfaces are in parallel to each other. Air passages in which the blown air flows are formed between the respective adjacent tubes 41 in the longitudinal direction of the tanks 42 to 45. Therefore, the multiple tubes 41 are stacked on each other, to thereby form heat exchanging unit (heat exchanging core portions) 40a and 40b that perform the heat exchange between the refrigerant and the blown air.

In addition, fins 46 that promote the heat exchange between the refrigerant and the blown air are disposed in the air passages provided between the respective adjacent tubes 41. The fins 46 are corrugated fins formed by bending a thin plate made of the same material as that of the tubes 41 in a wave shape, and top portions of the fins 46 are brazed to the flat surfaces of the tubes 41. Incidentally, FIG. 2 illustrates only a part of the fins 46 for clarification of the illustration. However, the fins 46 are disposed over a substantially entire area between the adjacent tubes 41.

Further, as described above, the tubes 41 according to the present embodiment are stacked on each other in two rows. In other words, the tubes 41 are disposed in the first row and the second row. Therefore, the heat exchanging unit includes a windward side heat exchanging unit 40a and a leeward side heat exchanging unit 40b. The windward side heat exchanging unit 40a is disposed in the first row of the tubes 41 and on the upstream side in the blown air flow direction. The leeward side heat exchanging unit 40b is disposed in the second row of the tubes 41 and on the downstream side in the blown air flow direction, and performs the heat exchange between the refrigerant and the blown air that has passed through the windward side heat exchanging unit 40a.

The tanks 42 to 45 are each formed of a bottomed cylindrical member made of the same material as that of the tubes 41. Cylindrical side surfaces of the tanks 42 to 45 are each provided with multiple slit holes that pierce through the tank. The tubes 41 are brazed to the tanks 42 to 45 in a state where the respective tubes 41 are inserted into those slit holes.

In the present embodiment, in the tanks 42 to 45, a tank that is connected to upper ends of the tubes 41 configuring the windward side heat exchanging unit 40a in the vertical direction (that is, gravity direction) is set as a windward side upper tank 42, and a tank that is connected to a lower end of the tubes 41 configuring the windward side heat exchanging unit 40a in the vertical direction is set as a windward side lower tank 43.

Further, in the tanks 42 to 45, a tank that is connected to upper ends of the tubes 41 configuring the leeward side heat exchanging unit 40b in the vertical direction is set as a leeward side upper tank 44, and a tank that is connected to a lower end of the tubes 41 configuring the leeward side heat exchanging unit 40b in the vertical direction is set as a leeward side lower tank 45.

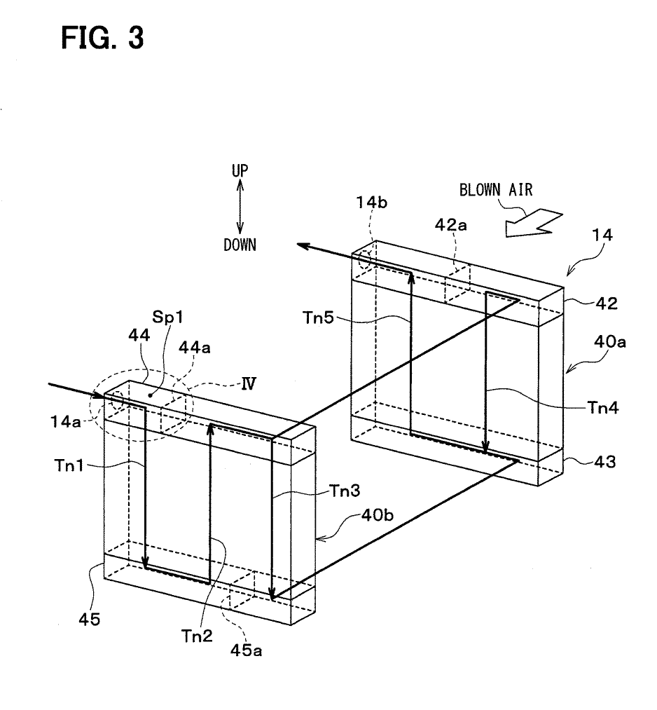

A bottom surface of the leeward side upper tank 44 on one end side in the longitudinal direction is provided with the refrigerant inlet port 14a as the overall evaporator 14, and a bottom surface of one end side of the windward side upper tank 42 in the longitudinal direction is provided with a refrigerant outlet port 14b as the overall evaporator 14. As illustrated in FIG. 3, separators 42a, 44a, and 45a are disposed inside of the windward side upper tank 42, the leeward side upper tank 44, and the leeward side lower tank 45, respectively, and the separators 42a, 44a, and 45a partition spaces in the respective tanks.

With the above configuration, in the evaporator 14 according to the present embodiment, the refrigerant flows as indicated by thick solid arrows in FIG. 3. Specifically, the refrigerant flow channel in the windward side heat exchanging unit 40a and the refrigerant passage in the leeward side heat exchanging unit 40b are connected to each other so that the refrigerant that has flowed into the refrigerant inlet port 14a flows in the windward side heat exchanging unit 40a after having flowed into the leeward side heat exchanging unit 40b. Incidentally, in FIG. 3, a distance between the windward side heat exchanging unit 40a and the leeward side heat exchanging unit 40b in the air flow direction is enlargedly illustrated for clarification of the illustration.

In the present embodiment, the fluid path provided by a group of the tubes 41 that allows the refrigerant distributed from one space in the tanks 42 to 45 to flow in the same direction in the tubes 41 is called “a turn path”. The “turn path” may be called “path”.

In the evaporator 14 according to the present embodiment, as illustrated in FIG. 3, the leeward side heat exchanging unit 40b is provided with three turn paths in which the refrigerant flows in the stated order of an inlet side turn path Tn1, a second turn path Tn2, and a third turn path Tn3. Further, the windward side heat exchanging unit 40a is provided with two turn paths in which the refrigerant flows in the stated order of a fourth turn path Tn4 and an outlet side turn path Tn5.

Also, in the present embodiment, multiple communication passages for communicating the refrigerant between the windward side heat exchanging unit 40a and the leeward side heat exchanging unit 40b are provided. Specifically, in the present embodiment, two communication passages including a communication passage for communicating between the other end side of the windward side upper tank 42 in the longitudinal direction and the other end side of the leeward side upper tank 44 in the longitudinal direction, and a communication passage for communicating between the other end side of the windward side lower tank 43 in the longitudinal direction and the other end side of the leeward side lower tank 45 in the longitudinal direction are provided.

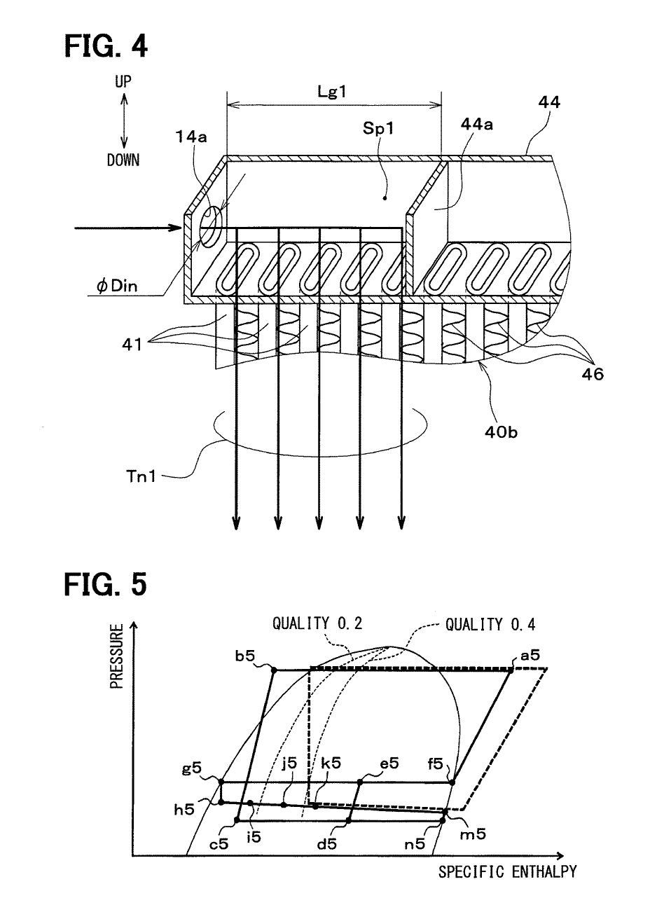

Next, an inlet side space Sp1 that is a space in which the refrigerant flows from the refrigerant inlet port 14a in the space of the leeward side upper tank 44, and the tubes 41 configuring the inlet side turn path Tn1 connected to the inlet side space Sp1 will be described in detail with reference to a schematic cross-sectional view of FIG. 4.

In the following description, it is assumed that a passage cross-sectional area of the refrigerant inlet port 14a is an inlet passage cross-sectional area Ain, and an equivalent diameter of the refrigerant inlet port 14a is an input equivalent diameter φDin. The inlet equivalent diameter φDin represents a diameter at the time of converting the inlet passage cross-sectional area Ain to a circle of the same area. Furthermore, it is assumed that a total value of the passage cross-sectional areas of the tubes 41 group configuring the inlet side turn path Tn1 is a total passage cross-sectional area AT1, and the diameter at the time of converting the total passage cross-sectional area AT1 to a circle of the same area is a total equivalent diameter φDa. Also, a length of the inlet side space Sp1 in the longitudinal direction of the leeward side upper tank 44 is Lg1.

First, in the evaporator 14 of the present embodiment, the respective dimensions are set so that a Reynolds number Re of the refrigerant immediately after having flowed from the inlet side space Sp1 into the tubes 41 configuring the inlet side turn path Tn1 satisfies the following Formula F1. The Reynolds number Re is calculated by the following Formulae F2 and F3.

Re≧1800 (F1)

Re=ρ×u×φDa/μ (F2)

u=Gr/ρ×AT1 (F3)

In the Formulae, ρ is a density of the refrigerant immediately after having flowed into the inlet side space Sp1, Gr is a flow rate (mass flow rate) of the refrigerant immediately after having flowed into the inlet side space Sp1, and μ is a saturated liquid viscosity coefficient of the refrigerant immediately after having flowed into the inlet side space Sp1.

Further, in the evaporator 14 of the present embodiment, the respective dimensions are set so that the following Formulae F4 and F5 are satisfied at the same time.

AT1/Ain≦3.5 (F4)

Lg1/Din≦25 (F5)

In more detail, in the present embodiment, it is assumed that Din is about 6 mm, Lg1 is about 89 mm, and AT1 is about 93 mm².

The refrigerant suction port 31b of the ejector 13 is connected to the refrigerant outlet port 14b side of the evaporator 14. Further, the gas-phase refrigerant outlet port 31d of the ejector 13 is connected with the intake side of the compressor 11.

The control device not shown includes a well-known microcomputer including a CPU, a ROM and a RAM, and peripheral circuits of the microcomputer. The control device controls the operation of the above-mentioned various electric actuators 11, 12d, 14c and so on by performing various calculations and processing on the basis of a control program stored in the ROM.

Further, the control device is connected with an air conditioning control sensor set such as an inside air temperature sensor for detecting a vehicle interior temperature, an outside air temperature sensor for detecting the temperature of an outside air, an insolation sensor for detecting the amount of insolation in the vehicle interior, an evaporator temperature sensor for detecting the blowing air temperature from the evaporator 14 (the temperature of the evaporator), an outlet side temperature sensor for detecting a temperature of the refrigerant on the outlet side of the radiator 12, and an outlet side pressure sensor for detecting a pressure of the refrigerant on the outlet side of the radiator 12. The detection values of those sensors are input to the control device.

Furthermore, an operation panel not shown, which is disposed in the vicinity of an instrument panel positioned at a front part in the vehicle interior, is connected to the input side of the control device, and operation signals output from various operation switches mounted on the operation panel are input to the control device. An air conditioning operation switch that is used to perform air conditioning in the vehicle interior, a vehicle interior temperature setting switch that is used to set the temperature of the vehicle interior, and the like are provided as the various operation switches that are mounted on the operation panel.

Meanwhile, the control device of the present embodiment is integrated with a control device for controlling the operations of various control target devices connected to the output side of the control device, but structure (hardware and software), which controls the operations of the respective control target devices, of the control device forms a control device of the respective control target devices. For example, in the present embodiment, a configuration which controls the operation of the electric motor of the compressor 11, configures a discharge capability control device.

Next, the operation of the present embodiment configured as described above will be described with reference to a Mollier diagram of FIG. 5. Incidentally, in FIG. 5, a change in a state of the refrigerant in the ejector refrigeration cycle 10 according to the present embodiment is indicated by a thick solid line, and a state of the refrigerant of a general refrigeration cycle device configured by connecting the compressor, the radiator, the expansion valve, and the evaporator in an annular shape is indicated by a thick broken line.

In the present embodiment, when the operation switch of the operation panel is turned on (ON), the control device actuates the electric motor of the compressor 11, the cooling fan 12d, the blower fan 14c, and so on. With the above configuration, the compressor 11 draws, compresses, and discharges the refrigerant.

A high-temperature high-pressure refrigerant (a point a5 in FIG. 5) discharged from the compressor 11 flows into the condensing portion 12a of the radiator 12, exchanges heat with an outside air blown from the cooling fan 12d, and is radiated and condensed. The refrigerant condensed by the condensing portion 12a is separated into gas and liquid by the receiver portion 12b. A liquid-phase refrigerant, which has been subjected to gas-liquid separation in the receiver portion 12b, is changed into a subcooled liquid-phase refrigerant by exchanging heat with the outside air, which has been blown from the cooling fan 12d in the subcooling portion 12c and further radiating heat (from point a5 to point b5 in FIG. 5).

The subcooled liquid-phase refrigerant that has flowed out of the subcooling portion 12c of the radiator 12 is isentropically depressurized by the nozzle passage 13a, and ejected (from point b5 to point c5 in FIG. 5). The nozzle passage 13c is defined between an inner peripheral surface of the depressurizing space 30b of the ejector 13 and an outer peripheral surface of the passage formation member 35. In this situation, a refrigerant passage area of the depressurizing space 30b in the minimum passage area portion 30m is regulated so that the degree of superheating of the refrigerant on the outlet side of the evaporator 14 comes closer to a predetermined value.

The refrigerant that has flowed out of the evaporator 14 (point m5 in FIG. 5) is drawn through the refrigerant suction port 31b and the suction passage 13b due to the drawing action of the ejection refrigerant which has been ejected from the nozzle passage 13a. The ejection refrigerant ejected from the nozzle passage 13a and the suction refrigerant drawn through the suction passage 13b flow into the diffuser passage 13c and join together (from point c5 to point d5, and from point n5 to point d5 in FIG. 5).

In this example, a downstream side of the suction passage 13b is shaped to gradually reduce the refrigerant passage area. For that reason, the suction refrigerant to pass through a suctioning passage 30d increases a flow velocity while reducing the pressure of the suction refrigerant (from point m5 to point n5 in FIG. 5). With the above configuration, a velocity difference between the suction refrigerant and the ejection refrigerant is reduced, and an energy loss (mixing loss) when mixing the suction refrigerant and the ejection refrigerant in the diffuser passage 13c can be reduced.

In the diffuser passage 13c, a kinetic energy of the refrigerant is converted into a pressure energy due to an increase in a refrigerant passage area. As a result, a pressure of the mixed refrigerant is increased while the ejection refrigerant and the suction refrigerant are mixed together (from point d5 to point e5 in FIG. 5). The refrigerant that has flowed out of the diffuser passage 13c is separated into gas and liquid in the gas-liquid separation space 30f (from point e5 to point f5, and from point e5 to point g5 in FIG. 5).

The liquid-phase refrigerant (point g5 in FIG. 5) separated in the gas-liquid separation space 30f is depressurized in the orifice 31i (from point g5 to point h5 in FIG. 5), and flows into the evaporator 14. The refrigerant that has flowed into the evaporator 14 absorbs heat from the blown air blown by the blower fan 14c, and evaporates (point h5, point i5, point j5, point k5, point l5, and point m5 in FIG. 5). Accordingly, the blown air is cooled.

In more detail, the refrigerant depressurized by the orifice 31i flows from the refrigerant inlet port 14a of the evaporator 14 into the inlet side space Sp1 provided in the leeward side upper tank 44. In this situation, the refrigerant to be introduced into the refrigerant inlet port 14a of the evaporator 14 is brought into the liquid-phase refrigerant obtained by subjecting the refrigerant (refrigerant having a lower pressure than that of the discharged refrigerant discharged by the compressor 11) depressurized by the nozzle passage 13a of the ejector 13 to gas-liquid separation by the gas-liquid separation space 30f.

For that reason, even if the liquid-phase refrigerant subjected to the gas-liquid separation in the gas-liquid separation space 30f is depressurized in the orifice 31i, the refrigerant immediately before flowing into the inlet side space Sp1 or immediately after having flowing into the inlet side space Sp1 is brought into a gas-liquid two-phase refrigerant having a relatively low vapor quality. According to the present inventors' study, in the ejector refrigeration cycle 10 according to the present embodiment, it is found that the vapor quality of the refrigerant immediately before flowing into the inlet side space Sp1 or immediately after having flowed into the inlet side space Sp1 becomes 0.2 or less, not depending on a load variation of the cycle.

When the refrigerant flows through the inlet side turn path Tn1, the refrigerant absorbs the heat from the blown air and increases the vapor quality (from point h5 to point i5 in FIG. 5). The refrigerant that has flowed out of the inlet side turn path Tn1 moves into the leeward side lower tank 45 and flows into the second turn path Tn2 illustrated in FIG. 3, and when the refrigerant flows in the second turn path Tn2, the refrigerant further absorbs the heat from the blown air and increases the vapor quality (from point i5 to point j5 in FIG. 5).

The refrigerant that has flowed out of the second turn path Tn2 moves into the leeward side upper tank 44, and a part of the refrigerant flows into the windward side upper tank 42 through the communication passage. The remaining refrigerant that has moved into the leeward side upper tank 44 flows into the third turn path Tn3 illustrated in FIG. 3, and when the refrigerant flows in the third turn path Tn3, the refrigerant further absorbs the heat from the blown air and increases the vapor quality (from point j5 to point k5 in FIG. 5).

The refrigerant that has flowed out of the third turn path Tn3 moves into the windward side lower tank 43 from the leeward side lower tank 45 through another communication passage. In the present embodiment, the heat exchange capability of the leeward side heat exchanging unit 40b is adjusted so that the vapor quality of the refrigerant that flows into the windward side heat exchanging unit 40a side from the leeward side heat exchanging unit 40b side through each communication passage becomes 0.4 or more and 0.5 or less.

The adjustment of the heat exchange capability described above can be performed by changing an area of the heat exchanging unit formed by, for example, the first to third turn paths Tn1 to Tn3.

Further, the refrigerant that has flowed from the leeward side upper tank 44 into the windward side upper tank 42 flows into the fourth turn path Tn4 illustrated in FIG. 4, and when the refrigerant flows in the fourth turn path Tn4, the refrigerant further absorbs the heat from the blown air and increases the vapor quality (from point j5 to point k5 in FIG. 5), and joins with the refrigerant that has flowed into the windward side lower tank 43 from the leeward side lower tank 45.

A joined refrigerant of the refrigerant that has flowed out of the third turn path Tn3 and the refrigerant that has flowed out of the fourth turn path Tn4 moves into the windward side lower tank 43 and flows into the outlet side turn path Tn5 illustrated in FIG. 3, and when the refrigerant flows in the outlet side turn path Tn5, the refrigerant further absorbs the heat from the blown air and increases the vapor quality (from point k5 to point m5 in FIG. 5).

On the other hand, the gas-phase refrigerant that has been separated in the gas-liquid separation space 30f flows out of the gas-phase refrigerant outlet port 31d, and is drawn into the compressor 11 and compressed again (point f5 to point a5 in FIG. 5).

The ejector refrigeration cycle 10 of the present embodiment operates as described above, and can cool the blown air to be blown into the vehicle interior. Further, in the ejector refrigeration cycle 10, since the refrigerant pressurized by the diffuser passage 13c is drawn into the compressor 11, the drive power of the compressor 11 can be reduced to improve the cycle of performance (COP).

Further, according to the ejector 13 of the present embodiment, the refrigerant is swirled in the swirling space 30a with the results that a refrigerant pressure on a swirling center side in the swirling space 30a can be reduced to a pressure of a saturated liquid-phase refrigerant, or a pressure at which the refrigerant is depressurized and boiled (cavitation occurs). With the above operation, a larger amount of gas-phase refrigerant is present on an inner peripheral side than an outer peripheral side of a swirling center axis. This leads to a two-phase separation state in which the refrigerant has a gas single phase in the vicinity of a swirling center line within the swirling space 30a, and has a liquid single phase around the vicinity thereof.

The refrigerant that has become in the two-phase separation state as described above flows into the nozzle passage 13a. As a result, in the convergent part 131 of the nozzle passage 13a, boiling of the refrigerant is promoted by the wall surface boiling generated when the refrigerant is separated from the outer peripheral side wall of the annular refrigerant passage, and the interface boiling caused by a boiling nucleus generated by the cavitation of the refrigerant on the center axis side of the annular refrigerant passage. Accordingly, the refrigerant that flows into the minimum passage area portion 30m of the nozzle passage 13a becomes in a gas-liquid mixed state in which the gas phase and the liquid phase are uniformly mixed together.

The flow of the refrigerant in the gas-liquid mixed state is blocked (choked) in the vicinity of the minimum passage area portion 30m. The refrigerant in the gas-liquid mixed state which reaches the sonic speed by the choking is accelerated in the divergent portion 132, and ejected. Accordingly, the refrigerant of the gas-liquid mixed state can be efficiently accelerated to the sonic speed by the boiling promotion caused by both of the wall surface boiling and the interface boiling. As a result, the energy conversion efficiency in the nozzle passage 13a can be improved.

In the ejector 13 according to the present embodiment, the passage formation member 35 is formed into a conical shape, a cross-sectional area of which increases with distance from the depressurizing space 30b. For that reason, the diffuser passage 13c can be shaped to expand toward the outer periphery of the passage formation member 35 with distance from the depressurizing space 30b. As a result, an axial dimension of the overall ejector 13 can be reduced.

Also, in the ejector 13 according to the present embodiment, since the gas-liquid separation space 30f is provided in the body 30, a capacity of the gas-liquid separation space 30f can be reduced as compared with a case in which the gas-liquid separator that exerts the same function as that of the ejector 13 is provided in addition to the ejector 13.

Incidentally, in the refrigeration cycle device of the cycle configuration in which the liquid-phase refrigerant separated by the gas-liquid separator flows into the evaporator as in the ejector refrigeration cycle 10 of the present embodiment, a larger amount of refrigerator oil is likely to be dissolved in the separated liquid-phase refrigerant. For that reason, the refrigerator oil concentration in the liquid-phase refrigerant to flow into the evaporator is likely to be increased.

Further, when the refrigerator oil concentration in the liquid-phase refrigerant flowing into the evaporator becomes high, the amount of refrigerator oil staying in the evaporator is increased, resulting in a risk that the refrigerator oil is stuck onto the inner wall surfaces of the tubes configuring the heat exchanging unit, and the heat exchanging performance of the evaporator is likely to be deteriorated.

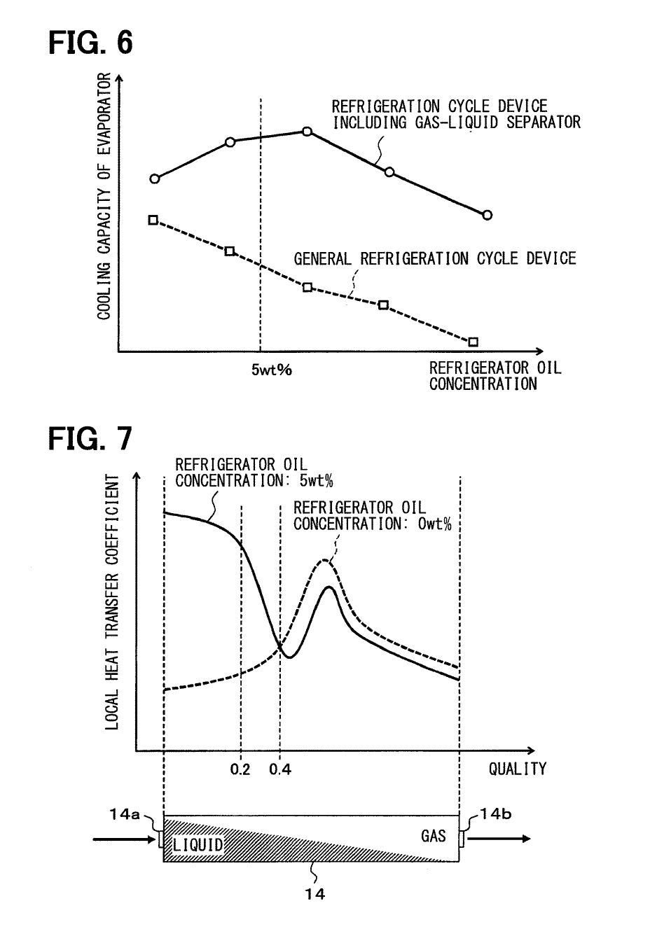

For that reason, in the “general refrigeration cycle device” configured by connecting the compressor, the radiator, the expansion valve, and the evaporator in an annular shape, as indicated by a thick broken line in FIG. 6, the cooling capacity of the evaporator is reduced with an increase in the refrigerator oil concentration in the liquid-phase refrigerant which flows into the evaporator.

However, according to the present inventors' test and study, in the “refrigeration cycle device having the gas-liquid separator” of the same cycle configuration as that of the ejector refrigeration cycle 10 of the present embodiment, it has been confirmed that, as indicated by a thick solid line of FIG. 6, the refrigerator oil concentration in the liquid-phase refrigerant to flow into the evaporator is increased to about 5 wt % to improve the cooling capacity of the overall evaporator. In more detail, it has been confirmed that the refrigerator oil concentration is brought closer to a predetermined concentration (peak concentration) to maximize the cooling capacity of the overall evaporator.

Further, as a result of investigating the mechanism of the refrigeration cycle device by the present inventors, it has been found that in the refrigeration cycle device in which the liquid-phase refrigerant separated by the gas-liquid separator is allowed to flow into the evaporator, the vapor quality of the refrigerant to flow into the evaporator becomes a relatively low value (specifically, the vapor quality of 0.2 or less), to thereby improve the cooling capacity of the evaporator.

The reason is because, in the refrigerant having the relatively low vapor quality, the refrigerator oil concentration is brought closer to the peak concentration, and grains of the refrigerator oil serve as boiling nucleus to promote the boiling of the liquid-phase refrigerant. With the promotion of the boiling of the liquid-phase refrigerant, the heat transfer coefficient in the tubes configuring a region in which the refrigerant having the relatively low vapor quality flows in the heat exchanging unit can be improved, and the cooling capacity of the overall evaporator can be improved.

In more detail, as illustrated in FIG. 7, in the region where the refrigerant having the vapor quality less than about 0.4 flows in the heat exchanging unit, the local heat transfer coefficient in that region can be improved when the refrigerant in which the refrigerator oil concentration is the peak concentration (about 5 wt %) is allowed to flow, as compared with the refrigerant in which the refrigerator oil is not dissolved.

Further, the local heat transfer coefficient in the region where the refrigerant having the vapor quality less than about 0.2 flows in the heat exchanging unit is higher than a maximum value of the local heat transfer coefficient when the refrigerant in which the refrigerator oil is not dissolved is allowed to flow.

FIG. 7 is a graph illustrating a relationship between the vapor quality of the refrigerant and the local heat transfer coefficient of the heat exchanging unit in the refrigerant flow channel extending from the inlet side to the outlet side of the evaporator. In the graph, the refrigerant in which the refrigerator oil concentration is about 5 wt % is indicated by a thick solid line, and the refrigerant in which the refrigerator oil concentration is 0% (that is, the refrigerator oil is not dissolved) is indicated by a solid broken line.

On the contrary, in the ejector refrigeration cycle 10 according to the present embodiment, since the refrigerator oil is mixed in the refrigerant so that the refrigerator oil concentration in the refrigerant to flow into the refrigerant inlet port 14a of the evaporator 14 becomes about 5 wt % (peak concentration) as described above, the cooling capacity of the overall evaporator 14 can be brought closer to the maximum value.

On the other hand, the heat transfer coefficient of the heat exchanging unit described above is improved in the region where the refrigerant having the relatively low vapor quality (specifically, the refrigerant having the vapor quality less than 0.4) flows in the heat exchanging unit. Furthermore, since the vapor quality is increased by progressing the evaporation of the refrigerant in the region where the refrigerant having the relatively high vapor quality (specifically, the refrigerant having the vapor quality more than 0.4) flows in the heat exchanging unit, the improvement in the heat transfer coefficient cannot be expected, but also the heat exchanging performance is deteriorated by an increase in the refrigerator oil concentration.

In addition, when the vapor quality of the refrigerant to flow into the evaporator is relatively low, since the flow velocity of the refrigerant that has flowed into the evaporator is decreased by an increase in the refrigerant density, the distributivity of distributing the refrigerant that has flowed into the evaporator to each tube is deteriorated.

For that reason, in the ejector refrigeration cycle 10 according to the present embodiment, when the refrigerator oil concentration to flow into the evaporator 14 is set to the peak concentration in which the cooling capacity of the evaporator is maximum, there is a risk that the inhomogeneous temperature distribution occurs in the blown air to be cooled by the evaporator 14.

On the contrary, according to the evaporator 14 of the present embodiment, the respective dimensions are set so that the Reynolds number Re of the refrigerant immediately after having flowed from the inlet side space Sp1 into the tubes 41 configuring the inlet side turn path Tn1 satisfies Formula F1.

Re≧1800 (F1)

Therefore, the flow velocity of the refrigerant flowing into the inlet side space Sp1 from the refrigerant inlet port 14a of the evaporator 14 is not largely decreased.

As a result, even in the evaporator 14 where the liquid-phase refrigerant separated by the gas-liquid separation space 30f of the ejector 13 is introduced into the refrigerant inlet port 14a side, the distributivity of distributing the refrigerant into each tube 41 configuring the inlet side turn path Tn1 from the inlet side space Sp1 can be restrained from being deteriorated.

In this example, the refrigerant flowing in the tubes 41 configuring the inlet side turn path Tn1 becomes the refrigerant relatively low in the vapor quality in the refrigerant flowing in the evaporator 14. For that reason, in the heat exchanging units 40a and 40b, a heat exchanging region on the inlet side configured by the inlet side turn path Tn1 becomes a region in which the high cooling capacity is exerted when the refrigerant mixed with the refrigerator oil flows.

Therefore, the distributivity of distributing the refrigerant to each tube 41 configuring the inlet side turn path Tn1 is restrained from being deteriorated, thereby being capable of homogenizing the inhomogeneous temperature distribution occurring in the blown air which has been cooled in the heat exchanging region on the inlet side. As a result, the inhomogeneous temperature distribution occurring in the cooled blown air can be effectively homogenized even in the overall evaporator 14.

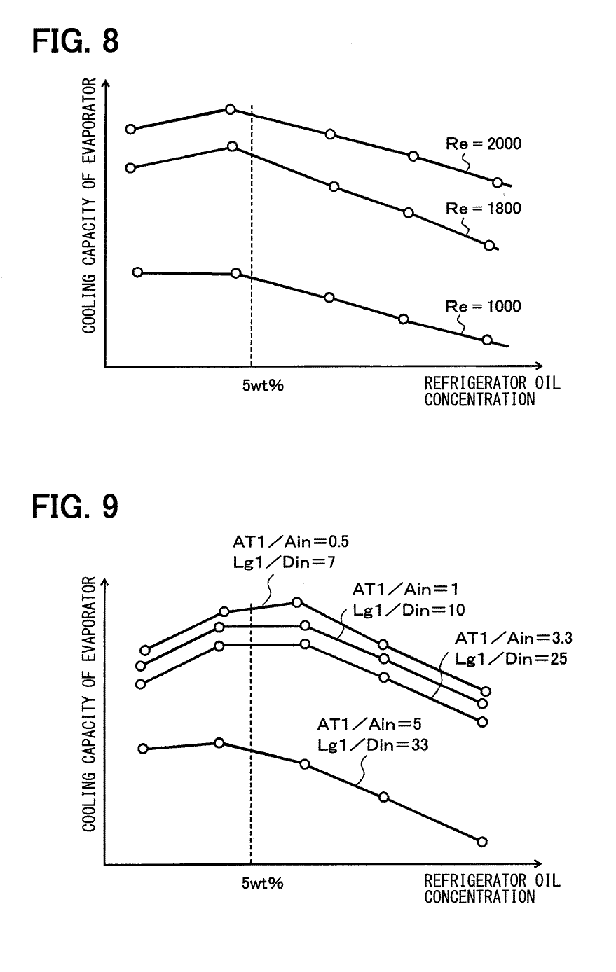

Further, according to the present inventors' test and study, as illustrated in FIG. 8, it has been confirmed that, in a range where the Reynolds number Re is equal to or more than 1800, the refrigerator oil concentration is brought closer to a predetermined concentration (peak concentration) to surely maximize the cooling capacity of the overall evaporator 14 not depending on the load variation of the cycle. Incidentally, the test results of FIG. 8 are confirmed under the following high-load operating condition and low-load operating condition.

In the high-load operating condition, the refrigerant flow rate (that is, corresponding to the above-mentioned refrigerant flow rate Gr) that flows in the cycle is about 130 kg/h, and the vapor quality of the refrigerant immediately before flowing into the evaporator 14 (specifically, the inlet side space Sp1) or immediately after having flowed into the evaporator 14 is about 0.01. Further, in the high-load operating condition, the refrigerant pressure on the outlet side of the evaporator 14 is about 0.31 MPa, and the degree of superheat of the refrigerant on the outlet side of the evaporator 14 is about 10° C.

In the low-load operating condition, the refrigerant flow rate that flows in the cycle is about 20 kg/h, and the vapor quality of the refrigerant immediately before flowing into the evaporator 14 (specifically, the inlet side space Sp1) or immediately after having flowed into the evaporator 14 is about 0.02. Further, in the low-load operating condition, the refrigerant pressure on the outlet side of the evaporator 14 is about 0.37 MPa, and the degree of superheat of the refrigerant on the outlet side of the evaporator 14 is about 3° C.

Further, according to the evaporator 14 of the present embodiment, the respective dimensions are set so that Formulae F4 and F5 are satisfied at the same time.

AT1/Ain≦3.5 (F4)

Lg1/Din≦25 (F5)

In this example, the flow velocity of the refrigerant to flow into the tubes 41 configuring the inlet side turn path Tn1 is increased with a reduction in the total passage cross-sectional area AT1 relative to the inlet passage cross-sectional area Ain. Therefore, with a reduction in the ratio (AT1/Ain) of the total passage cross-sectional area AT1 to the inlet passage cross-sectional area Ain, the distributivity of distributing the refrigerant to each tube 41 configuring the inlet side turn path Tn1 from the inlet side space Sp1 is likely to be improved.

Also, with a reduction in a length Lg1 in the longitudinal direction relative to the inlet equivalent diameter Din, the refrigerant is likely to arrive at the tube 41 most distant from the refrigerant inlet port 14a. Therefore, with a reduction in the ratio (Lg1/Din) of the longitudinal direction length Lg1 to the input equivalent diameter Din, the distributivity of distributing the refrigerant to each tube 41 configuring the inlet side turn path Tn1 from the inlet side space Sp1 is likely to be improved.

Further, according to the present inventors' study, it is found that the respective dimensions are set so that Formulae F4 and F5 are satisfied at the same time whereby as illustrated in the graph of FIG. 9, the distributivity of distributing the refrigerant to each tube 41 configuring the inlet side turn path Tn1 from the inlet side space Sp1 can be sufficiently restrained from being deteriorated while exerting the high cooling capacity of the overall evaporator 14. As a result, the inhomogeneous temperature distribution occurring in the cooled blown air can be effectively homogenized even in the overall evaporator 14.

Also, according to the evaporator 14 of the present embodiment, the heat exchanging unit includes the windward side heat exchanging unit 40a and the leeward side heat exchanging unit 40b. The windward side heat exchanging unit 40a and the leeward side heat exchanging unit 40b are connected to each other so that the refrigerant that has flowed into the refrigerant inlet port 14a flows in the stated order of the leeward side heat exchanging unit 40b and the windward side heat exchanging unit 40a. Therefore, the blown air cooled by the windward side heat exchanging unit 40a can be further cooled by the leeward side heat exchanging unit 40b.

In the above configuration, when viewed from the flow direction of the blown air, for example, a region in which the high cooling capacity is exerted in the leeward side heat exchanging unit 40b and a region in which the cooling capacity is decreased in the windward side heat exchanging unit 40a can overlap with each other. Therefore, the inhomogeneous temperature distribution occurring in the blown air is likely to be homogenized.

Further, in the present embodiment, the vapor quality of the refrigerant that flows into the refrigerant inlet port 14a is set to 0.2 or less, and the vapor quality of the refrigerant flowing from the leeward side heat exchanging unit 40b side to the windward side heat exchanging unit 40a side is set to 0.4 or more and 0.5 or less.

According to the above configuration, in the leeward side heat exchanging unit 40b, the refrigerant having the relatively low vapor quality (specifically, the refrigerant having the vapor quality of about 0.2 to 0.4) can be evaporated. Also, in the windward side heat exchanging unit 40a, the refrigerant having the relatively high vapor quality (specifically, the refrigerant of the vapor quality of 0.4 or more) can be evaporated. Therefore, the leeward side heat exchanging unit 40b can be brought into a region where the cooling capacity higher than that of the windward side heat exchanging unit 40a can be exerted.

According to the above configuration, the inhomogeneous temperature distribution occurring in the fluid to be cooled which has been cooled by the windward side heat exchanging unit 40a and the inhomogeneous temperature distribution occurring in the fluid cooled by the leeward side heat exchanging unit 40b can be homogenized. As a result, the inhomogeneous temperature distribution occurring in the cooled blown air can be further effectively homogenized in the overall evaporator 14.

Further, in the present embodiment, since the inlet side space Sp1 is provided in the leeward side upper tank 44, the cooling capacity exerted by the leeward side heat exchanging unit 40b can be improved more than the cooling capacity exerted by the windward side heat exchanging unit 40a. Therefore, a temperature difference between the temperatures of the windward side heat exchanging unit 40a and the leeward side heat exchanging unit 40b and the temperature of the blown air is ensured, and the blown air can be efficiently cooled.

Also, according to the evaporator 14 of the present embodiment, the multiple communication passages for communicating the refrigerant between the windward side heat exchanging unit 40a and the leeward side heat exchanging unit 40b are provided. Therefore, a passage pressure loss when the refrigerant flows in the evaporator 14 can be reduced.

### Second Embodiment

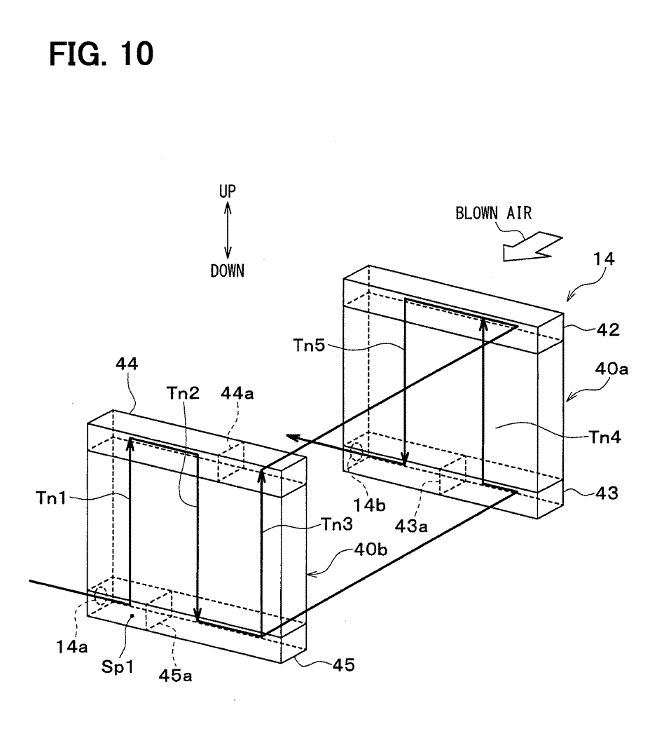

In the present embodiment, as illustrated in FIG. 10, an example in which a refrigerant flow channel configuration in an evaporator 14 is changed as compared with the first embodiment will be described. FIG. 10 is a diagram corresponding to FIG. 3 in the first embodiment.

Specifically, in the present embodiment, a refrigerant inlet port 14a is provided in a bottom surface of a leeward side lower tank 45 on one end side in the longitudinal direction of the leeward side lower tank 45. Therefore, an inlet side space Sp1 according to the present embodiment is provided in the leeward side lower tank 45. Further, a refrigerant outlet port 14b is provided in a bottom surface of a windward side lower tank 43 on one end side in the longitudinal direction.

As illustrated in FIG. 10, separators 43a, 44a, and 45a are disposed inside of the windward side lower tank 43, the leeward side upper tank 44, and the leeward side lower tank 45, respectively, and the separators 43a, 44a, and 45a partition spaces in the respective tanks.

With the above configuration, in the evaporator 14 according to the present embodiment, the refrigerant flows as indicated by thick solid arrows in FIG. 10. Specifically, as in the first embodiment, the refrigerant passage in the windward side heat exchanging unit 40a and the refrigerant flow channel in the leeward side heat exchanging unit 40b are connected to each other so that the refrigerant that has flowed into the refrigerant inlet port 14a flows in the windward side heat exchanging unit 40a after having flowed into the leeward side heat exchanging unit 40b.

In the evaporator 14 according to the present embodiment, as illustrated in FIG. 10, the leeward side heat exchanging unit 40b is provided with three turn paths in which the refrigerant flows in the stated order of an inlet side turn path Tn1, a second turn path Tn2, and a third turn path Tn3. Further, the windward side heat exchanging unit 40a is provided with two turn paths in which the refrigerant flows in the stated order of a fourth turn path Tn4 and an outlet side turn path Tn5.

The other configuration and operation of the evaporator 14 and the ejector refrigeration cycle 10 are similar to those of the first embodiment. Therefore, even in the evaporator 14 of the present embodiment, as in the first embodiment, the inhomogeneous temperature distribution occurring in the blown air cooled by the evaporator 14 can be effectively homogenized.

Further, in the present embodiment, since the inlet side space Sp1 is provided in the leeward side lower tank 45, the refrigerant that has flowed into the inlet side space Sp1 can be restrained from flowing into the tubes 41 close to the refrigerant inlet port 14a due to the action of the gravity force. Therefore, the distributivity of distributing the refrigerant to each tube 41 configuring the inlet side turn path Tn1 from the inlet side space Sp1 can be further more improved.

### Third Embodiment

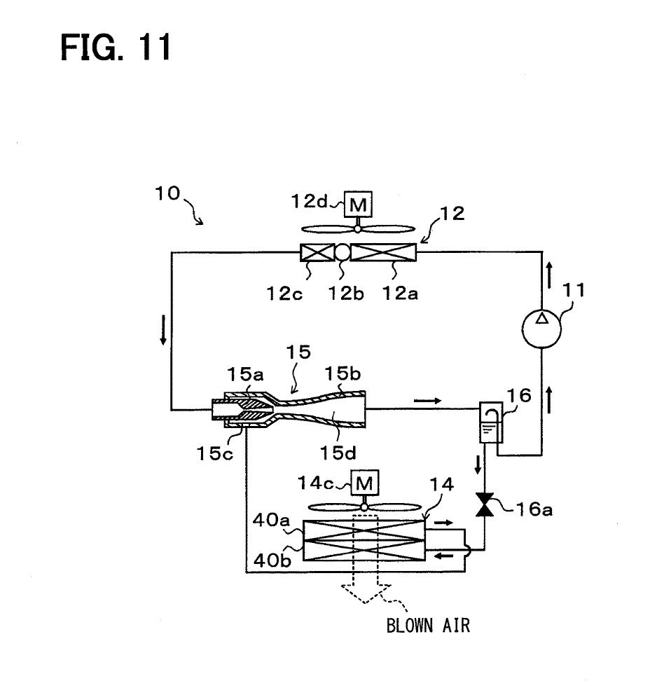

In the embodiments described above, the example in which the evaporator 14 is applied to the ejector refrigeration cycle 10 having the ejector 13 with the gas-liquid separation function has been described. On the other hand, in the present embodiment, as illustrated in an overall configuration diagram of FIG. 11, an evaporator 14 is applied to an ejector refrigeration cycle 10 having an ejector 15 and a gas-liquid separator 16 configured as different configuration equipments from each other.

More specifically, an ejector 15 according to the present embodiment has a nozzle portion 15a and a body portion 15b. The nozzle portion 15a is formed of a substantially cylindrical metal (for example, stainless steel alloy) or the like that is gradually tapered toward a refrigerant flowing direction, and reduces the pressure and expands the refrigerant in an isentropic manner in a refrigerant passage (throttle passage) defined on the inside of the nozzle portion 15a.

In the present embodiment, in the nozzle portion 15a, a flow velocity of the ejection refrigerant ejected from a refrigerant ejection port is set to be equal to or higher than a sound speed during normal operation of the ejector refrigeration cycle 10. The nozzle portion 15a may be configured by any of a Laval nozzle and a convergent nozzle.

The body portion 15b is made of metal (for example, aluminum) or resin formed into substantially a cylindrical shape, functions as a fixing member for internally supporting and fixing the nozzle portion 15a, and forms an outer shell of the ejector 15. More specifically, the nozzle portion 15a is fixed by press fitting so as to be housed in the interior of the body portion 15b on one end side in the longitudinal direction of the body portion 15b. Therefore, the refrigerant is not leaked from a fixing portion (press-fitting part) of the nozzle portion 15a and the body portion 15b.

In addition, a portion corresponding to an outer peripheral side of the nozzle portion 15a in an outer peripheral surface of the body portion 15b is formed with a refrigerant suction port 15c that is provided to penetrate through the body portion 15b and communicate with the refrigerant ejection port of the nozzle portion 15a. The refrigerant suction port 15c is a through hole for drawing the refrigerant that has flowed out of the evaporator 14 into the interior of the ejector 15 from the exterior due to the drawing action of the ejection refrigerant ejected from the nozzle portion 15a.

The interior of the body portion 15b is formed with a suctioning passage and a diffuser portion 15d serving as a pressure increase portion. The suctioning passage is provided for introducing the suction refrigerant drawn from the refrigerant suction port 15c to the refrigerant ejection port side of the nozzle portion 15a. The diffuser portion 15d mixes the suction refrigerant that has flowed into the ejector 15 from the refrigerant suction port 15c through the suction passage with the ejection refrigerant to increase the pressure.

The diffuser portion 15d is disposed to be continuous to an outlet of the suctioning passage, and formed by a space that gradually increases a refrigerant passage area. With the above configuration, the diffuser portion 15d performs a function of increasing a pressure of the mixed refrigerant of the ejection refrigerant and the suction refrigerant by decreasing the flow velocity of the refrigerant while the ejection refrigerant is mixed with the suction refrigerant, that is, a function of converting a velocity energy of the mixed refrigerant into a pressure energy.

The gas-liquid separator 16 is a gas-liquid separator that separates the refrigerant that has flowed out of the diffuser portion 15d of the ejector 15 into gas and liquid. Incidentally, in the present embodiment, the gas-liquid separator 16 is relatively small in an internal capacity so as to allow the separated liquid-phase refrigerant to flow from the liquid-phase refrigerant outlet port without almost storing the liquid-phase refrigerant. Alternatively, the gas-liquid separator 16 may have a function as a reservoir device for storing the excess liquid-phase refrigerant in the cycle.

The gas-phase refrigerant outlet port of the gas-liquid separator 16 is connected with a suction side of the compressor 11. A liquid-phase refrigerant outlet port of the gas-liquid separator 16 is connected with a refrigerant inlet port 14a side of the evaporator 14 through a fixed throttle 16a. The fixed throttle 16a performs the same function as that of the orifice 31i described in the first embodiment, and specifically can employ an orifice, a capillary tube, and so on.

The other configurations and operation of the ejector refrigeration cycle 10 are identical with those in the first embodiment. In other words, the ejector refrigeration cycle 10 according to the present embodiment has the cycle configuration substantially equivalent to the cycle described in the above embodiment.

For that reason, similarly, in the present embodiment, the refrigerator oil concentration of the refrigerant to flow from the refrigerant inlet port 14a of the evaporator 14 becomes the peak concentration that maximizes the cooling capacity of the evaporator 14, and the vapor quality becomes equal to or less than 0.2. Therefore, even in the evaporator 14 of the present embodiment, as in the first embodiment, the inhomogeneous temperature distribution occurring in the cooled blown air can be effectively homogenized while exerting the high cooling capacity of the overall evaporator 14.

### Other Embodiments

The present invention is not limited to the above-described embodiments, but various modifications can be made thereto as follows without departing from the spirit of the present invention. Devices disclosed in the respective embodiments may be appropriately combined together in an implementable range. For example, the evaporator 14 described in the second embodiment may be applied to the ejector refrigeration cycle 10 described in the third embodiment.

(1) In the above embodiments, the example in which the evaporator 14 according to the present disclosure is applied to the ejector refrigeration cycle 10 has been described, but the refrigeration cycle device that can employ the evaporator 14 of the present disclosure is not limited to the above configuration.

The evaporator 14 according to the present disclosure is effectively applied to the refrigeration cycle device in which the vapor quality of the refrigerant to flow from the refrigerant inlet port 14a is a relatively low value (specifically, vapor quality of 0.2 or less). Therefore, the evaporator 14 is effectively applied to the refrigeration cycle device in which the gas-liquid separator is disposed on the upstream side of the evaporator 14, and the liquid-phase refrigerant separated by the gas-liquid separator is introduced into the refrigerant inlet port 14a side.

Further, it is desirable that the refrigerant to be separated into the gas and liquid by the gas-liquid separator is the refrigerant depressurized to a pressure lower than that of the high-pressure refrigerant discharged from the compressor 11 as described in the above embodiments. The reason is because the vapor quality of the refrigerant to flow from the refrigerant inlet port 14a becomes lower as a pressure reduction amount in the refrigerant passage extending from the gas-liquid separator to the evaporator 14 is smaller.

For example, the evaporator 14 according to the present disclosure may be applied to a refrigeration cycle device (economizer refrigeration cycle) of a cycle configuration which includes: a compressor that increases a pressure of a refrigerant in multiple stages; a radiator that performs a heat exchange between a high-pressure refrigerant discharged from the compressor and an outside air (or a fluid to be heated); a high-stage side depressurizing device for depressurizing the refrigerant that has flowed out of the radiator to an intermediate pressure refrigerant; a gas-liquid separator that separates the refrigerant depressurized by the high-state side depressurizing device into a gas and a liquid; and a low-stage side depressurizing device for depressurizing a liquid-phase refrigerant separated by the gas-liquid separator to a low-pressure refrigerant, in which a gas-phase refrigerant separated by the gas-liquid separator is allowed to flow into an intermediate-pressure refrigerant inlet port of the compressor.

Further, when the evaporator 14 is applied to the economizer refrigeration cycle, the outlet side of the low-stage side depressurizing device may be connected with the refrigerant inlet port 14a side of the evaporator 14, and the refrigerant outlet port 14b of the evaporator 14 may be connected with the low-pressure refrigerant suction side of the compressor.

(2) In the embodiments described above, the configuration in which the inlet side space Sp1 is provided in the leeward side tank (the leeward side upper tank 44 and the leeward side lower tank 45), and the refrigerant that has flowed into the evaporator 14 is allowed to flow in the stated order of the leeward side heat exchanging unit 40b and the windward side heat exchanging unit 40a has been described. However, the refrigerant flow channel configuration in the evaporator 14 is not limited to this configuration.

For example, the inlet side space Sp1 may be provided in the windward side tank (the windward side upper tank 42 and the windward side lower tank 43), and the refrigerant that has flowed into the evaporator 14 may be allowed to flow in the stated order of the windward side heat exchanging unit 40a and the leeward side heat exchanging unit 40b.

(3) The respective configuration equipments configuring the ejector refrigeration cycle 10 are not limited to the equipments disclosed in the above embodiments.

For example, in the embodiments described above, the example in which the electric compressor is employed as the compressor 11 has been described. Alternatively, the compressor 11 may be configured by an engine driven compressor that is driven by a rotational driving force that is transmitted from a vehicle travel engine through a pulley, a belt, and so on. Further, as the engine driven compressor, a variable capacity type compressor that can adjust a refrigerant discharge capacity by a change in discharge capacity, or a fixed capacity type compressor that adjusts the refrigerant discharging capacity by changing an operation rate of the compressor through connection/disconnection of an electromagnetic clutch can be applied.

In addition, in the above-described embodiments, examples in which a subcooling heat exchanger is employed as the radiator 12 have been described, but, it is needless to say that a normal radiator formed of only the condensing portion 12a may be employed as the radiator 12. Further, with a normal radiator, a liquid receiver (receiver) that separates the refrigerant radiated by the radiator into gas and liquid, and stores an excess liquid-phase refrigerant may be employed.

(4) In the above embodiments, the example in which the refrigeration cycle device (ejector refrigeration cycle 10) equipped with the evaporator 14 of the present disclosure is applied to the vehicle air conditioning apparatus has been described, but the application of the refrigeration cycle device equipped with the evaporator 14 of the present disclosure is not limited to this configuration. For example, the ejector refrigeration cycle 10 may be applied to, for example, a stationary air conditioning apparatus, cold storage warehouse, a vending machine for cooling heating device, and so on.

The present disclosure has been described based on the embodiments; however, it is understood that this disclosure is not limited to the embodiments or the structures. The present disclosure includes various modification examples, or modifications within an equivalent range. In addition, various combinations or forms, and other combinations or forms including only one element, more than or less than one among these combinations or forms are included in the scope or the technical scope of the present disclosure.

What is claimed is:

1. An evaporator for a vapor compression refrigeration cycle device in which a refrigerator oil is mixed with a refrigerant, the evaporator comprising:
a refrigerant inlet port into which a liquid-phase refrigerant obtained via separation of the refrigerant by a gas-liquid separator is introduced;
a heat exchanging unit that includes a plurality of tubes which are stacked and allow the refrigerant to flow therein, and performs a heat exchange between the refrigerant and a fluid to be cooled; and
a tank that extends in a stacking direction of the plurality of tubes, is connected to ends of the plurality of tubes, and gathers the refrigerant from the plurality of tubes or distributes the refrigerant to the plurality of tubes, wherein
fluid paths, each of which is provided by a group of the plurality of tubes that allows the refrigerant distributed from one space in the tank to flow in the same direction, are defined as turn paths,
the tank has an inlet side space into which the refrigerant flows from the refrigerant inlet port,
one of the turn paths connected to the inlet side space is defined as an inlet side turn path,
it is defined that p is a density of the refrigerant flowing into the inlet side space, Gr is a mass flow rate of the refrigerant flowing into the inlet side space, AT1 is a total passage cross-sectional area of a group of the plurality of tubes forming the inlet side turn path, φDa is a total equivalent diameter of the total passage cross-sectional area, and μ is a saturated liquid viscosity coefficient of the refrigerant flowing into the inlet side space,
a Reynolds number Re of the refrigerant that has flowed into the inlet side turn path is represented by
Re=ρ×u×φDa/μ,
u=Gr/ρ×AT1, and
Re≧1800 is satisfied.

2. An evaporator for a vapor compression refrigeration cycle device in which a refrigerator oil is mixed with a refrigerant, the evaporator comprising:
a refrigerant inlet port into which a liquid-phase refrigerant obtained via separation of the refrigerant by a gas-liquid separator is introduced;
a heat exchanging unit that includes a plurality of tubes which are stacked and allow the refrigerant to flow therein, and performs a heat exchange between the refrigerant and a fluid to be cooled; and
a tank that extends in a stacking direction of the plurality of tubes, is connected to ends of the plurality of tubes, and gathers the refrigerant from the plurality of tubes or distributes the refrigerant to the plurality of tubes, wherein
fluid paths, each of which is provided by a group of the plurality of tubes that allows the refrigerant distributed from one space in the tank to flow in the same direction, are defined as turn paths,
the tank has an inlet side space into which the refrigerant flows from the refrigerant inlet port,
one of the turn paths connected to the inlet side space is defined as an inlet side turn path,
it is defined that an inlet passage cross-sectional area of the refrigerant inlet port is Ain, and a total passage cross-sectional area of a group of the plurality of tubes forming the inlet side turn path is AT1,
AT1/Ain≦3.5 is satisfied,
it is defined that an input equivalent diameter of the refrigerant inlet port is Din, and a length of the inlet side space in the stacking direction is Lg1, and
Lg1/Din≦25 is satisfied.

3. The evaporator according to claim 1, wherein
the plurality of tubes are stacked into a first row and a second row,
the heat exchanging unit includes:
a windward side heat exchanging unit that includes the first row of the plurality of tubes and performs a heat exchange between the refrigerant and the fluid to be cooled; and
a leeward side heat exchanging unit that is disposed on a downstream side of the windward side heat exchanging unit in a flow direction of the fluid to be cooled, the leeward side heat exchanging unit including the second row of the plurality of tubes and performing a heat exchange between the refrigerant and the fluid to be cooled, and
a refrigerant flow channel in the windward side heat exchanging unit and a refrigerant flow channel in the leeward side heat exchanging unit are connected to each other such that the refrigerant that has flowed into the refrigerant inlet port passes through one of the windward side heat exchanging unit and the leeward side heat exchanging unit and thereafter passes through another of the windward side heat exchanging unit and the leeward side heat exchanging unit.

4. The evaporator according to claim 3, wherein
the tank includes a leeward tank that is connected with the second row of the plurality of tubes of the leeward side heat exchanging unit, and a windward tank that is connected with the first row of the plurality of tubes of the windward side heat exchanging unit, and
the inlet side space is located in the leeward tank.

5. The evaporator according to claim 3, further comprising a plurality of communication passages through which the refrigerant flows between the windward side heat exchanging unit and the leeward side heat exchanging unit

6. The evaporator according to claim 3, wherein one of the windward side heat exchanging unit and the leeward side heat exchanging unit is configured to obtain 0.4 or more in vapor quality of the refrigerant flowing out of the one of the windward side heat exchanging unit and the leeward side heat exchanging unit and flowing into another of the windward side heat exchanging unit and the leeward side heat exchanging unit.

7. The evaporator according to claim 1, wherein the refrigeration cycle device is configured to obtain 0.2 or less in vapor quality of the refrigerant flowing into the refrigerant inlet port.

8. An evaporator for a vapor compression refrigeration cycle device in which a refrigerator oil is mixed with a refrigerant, the evaporator comprising:
a refrigerant inlet port into which a liquid-phase refrigerant obtained via separation of the refrigerant by a gas-liquid separator is introduced;
a heat exchanging unit that includes a plurality of tubes which are stacked and allow the refrigerant to flow therein, and performs a heat exchange between the refrigerant and a fluid to be cooled; and
a tank that extends in a stacking direction of the plurality of tubes, is connected to ends of the plurality of tubes, and gathers the refrigerant from the plurality of tubes or distributes the refrigerant to the plurality of tubes, wherein
the plurality of tubes are stacked into a first row and a second row,
the heat exchanging unit includes:
a windward side heat exchanging unit that includes the first row of the plurality of tubes and performs a heat exchange between the refrigerant and the fluid to be cooled; and
a leeward side heat exchanging unit that is disposed on a downstream side of the windward side heat exchanging unit in a flow direction of the fluid to be cooled, the leeward side heat exchanging unit including the second row of the plurality of tubes and performing a heat exchange between the refrigerant and the fluid to be cooled,
a refrigerant flow channel in the windward side heat exchanging unit and a refrigerant flow channel in the leeward side heat exchanging unit are connected to each other such that the refrigerant that has flowed into the refrigerant inlet port passes through one of the windward side heat exchanging unit and the leeward side heat exchanging unit and thereafter passes through another of the windward side heat exchanging unit and the leeward side heat exchanging unit,
the refrigeration cycle device is configured to obtain 0.2 or less in vapor quality of the refrigerant that flows into the refrigerant inlet port, and
one of the windward side heat exchanging unit and the leeward side heat exchanging unit is configured to obtain 0.4 or more in vapor quality of the refrigerant flowing out of the one of the windward side heat exchanging unit and the leeward side heat exchanging unit and flowing into another of the windward side heat exchanging unit and the leeward side heat exchanging unit.

9. The evaporator according to claim 1, wherein the inlet side space is located in the tank connected to lower ends of the plurality of tubes in a vertical direction.

10. The evaporator according to claim 1, wherein
the refrigeration cycle device includes a compressor that compresses and discharges the refrigerant, and
the gas-liquid separator separates gas and liquid of the refrigerant that has been depressurized to a pressure lower than a high-pressure refrigerant discharged from the compressor.

11. The evaporator according to claim 1, wherein
the refrigeration cycle device includes a compressor that compresses and discharges the refrigerant, and
the refrigeration cycle device includes an ejector that draws the refrigerant from outside by a drawing action of an ejection refrigerant ejected from a nozzle portion that depressurizes a high-pressure refrigerant discharged from the compressor.

12. The evaporator according to claim 2, wherein
the plurality of tubes are stacked into a first row and a second row,
the heat exchanging unit includes:
a windward side heat exchanging unit that includes the first row of the plurality of tubes and performs a heat exchange between the refrigerant and the fluid to be cooled, and
a leeward side heat exchanging unit that is disposed on a downstream side of the windward side heat exchanging unit in a flow direction of the fluid to be cooled, the leeward side heat exchanging unit including the second row of the plurality of tubes and performing a heat exchange between the refrigerant and the fluid to be cooled, and
a refrigerant flow channel in the windward side heat exchanging unit and a refrigerant flow channel in the leeward side heat exchanging unit are connected to each other such that the refrigerant that has flowed into the refrigerant inlet port passes through one of the windward side heat exchanging unit and the leeward side heat exchanging unit and thereafter passes through another of the windward side heat exchanging unit and the leeward side heat exchanging unit.

13. The evaporator according to claim 12, wherein
the tank includes a leeward tank that is connected with the second row of the plurality of tubes of the leeward side heat exchanging unit, and a windward tank that is connected with the first row of the plurality of tubes of the windward side heat exchanging unit, and
the inlet side space is located in the leeward tank.

14. The evaporator according to claim 12, further comprising a plurality of communication passages through which the refrigerant flows between the windward side heat exchanging unit and the leeward side heat exchanging unit

15. The evaporator according to claim 12, wherein one of the windward side heat exchanging unit and the leeward side heat exchanging unit is configured to obtain 0.4 or more in vapor quality of the refrigerant flowing out of the one of the windward side heat exchanging unit and the leeward side heat exchanging unit and flowing into another of the windward side heat exchanging unit and the leeward side heat exchanging unit.

16. The evaporator according to claim 2, wherein the refrigeration cycle device is configured to obtain 0.2 or less in vapor quality of the refrigerant flowing into the refrigerant inlet port.

17. The evaporator according to claim 2, wherein the inlet side space is located in the tank connected to lower ends of the plurality of tubes in a vertical direction.

18. The evaporator according to claim 2, wherein
the refrigeration cycle device includes a compressor that compresses and discharges the refrigerant, and
the gas-liquid separator separates gas and liquid of the refrigerant that has been depressurized to a pressure lower than a high-pressure refrigerant discharged from the compressor.

19. The evaporator according to claim 2, wherein
the refrigeration cycle device includes a compressor that compresses and discharges the refrigerant, and
the refrigeration cycle device includes an ejector that draws the refrigerant from outside by a drawing action of an ejection refrigerant ejected from a nozzle portion that depressurizes a high-pressure refrigerant discharged from the compressor.
